(19) United States
(12) Patent Application Publication
(10) Pub. No.: US 2018/0332526 A1
(43) Pub. Date: Nov. 15, 2018

(54) Optimizing MuLTEfire Network Discovery

(71) Applicant: Nokia Solutions and Networks Oy, Espoo (FI)

(72) Inventors: Jari Pekka MUSTAJARVI, Espoo (FI); Stephen MAGEE, Scottsdale, AZ (US)

(21) Appl. No.: 15/774,453

(22) PCT Filed: Nov. 11, 2015
(86) PCT No.: PCT/US2015/060158

§ 371 Date: May 8, 2018

(51) Int. Cl. H04W 48/16; H04W 4/06; H04W 40/24; H04W 48/08

(52) U.S. Cl. CPC H04W 48/16; H04W 4/06; H04W 84/12; H04W 48/08; H04W 40/244

(57) ABSTRACT

Various communication systems may benefit from appropriate discovery mechanisms. More particularly, MuLTEfire network discovery may benefit from mechanisms that optimize discovery. A method can include determining whether more network access related information is available than can fit in a beacon. The method can also include sending the beacon with some network access related information. The method can further include including, with the beacon, an indicator regarding whether additional network access related information is available, based on the determination of whether more network access related information is available than can fit in the beacon.

### BACKGROUND

### Field

Various communication systems may benefit from appropriate discovery mechanisms. More particularly, MuLTEfire network discovery may benefit from mechanisms that optimize discovery.

### Description of the Related Art

MuLTEfire (MLF) may be a new communications system where long term evolution (LTE) radio technology is applied to an unlicensed radio band. A difference from the currently on-going licensed assisted access (LAA) and LTE unlicensed (LTE-U) activities is that with MLF, there may not be expected to be a macro network nor licensed carriers in use instead of unlicensed band. Thus, MLF can be a standalone system designed to operate on unlicensed band frequencies, for example on the same 5 GHz band as Wi-Fi operates.

On a radio interface, MLF is expected to rely on LTE technology with as few modifications as possible. The LTE radio physical layer and related protocols are already being modified for the unlicensed operation including listen-before-talk (LBT) mechanisms for channel access. However, currently the unlicensed access relies on control information and signaling exchanged on the licensed carrier. MLF is expected to operate entirely on the unlicensed carriers.

MLF may extend LTE coverage and may partly follow LTE network selection when deployed by mobile network operators (MNO). MLF may also create MNO independent networks (non-MNO), similar to WLAN model. MLF could be even used for residential access, similar to Femto or WLANMLF may have versatile characteristics and therefore various use cases from residential use to MNO extension. The same MLF network may support both MNO and non-MNO models.

When operating in a non-MNO model, devices do not necessary look for networks based on broadcasted public land mobile network (PLMN) identifiers and on a PLMN in the SIM card. A different type of broadcast information is needed, indicating service providers in non-MNO model. Similar to Wi-Fi Alliance Hotspot 2.0 WLAN model, MLF network may have specific local operator but it may provide services to customers of multiple service providers. In extreme cases the local operator may only host the MLF access networks but may not itself provide MLF accounts for the end users or local operator provides services only for own users. Nevertheless, devices need to find out which MLF networks provide services to the user. Due to plurality of the potential different MLF networks and limited space in the beacon to host all possible service providers, network discovery in such environment may become a burden.

In HS2.0 the user equipment (UE) has to explicitly query the access point (AP) to receive available additional information which is not included into beacon broadcast. There is an “Access Network Type” field that is used to indicate access characteristics of the network (e.g. private, private with guest access). The use of this information by the UE is implementation specific.

WLAN beacon includes separate indicator about HS2.0 support. This does not indicate whether WLAN has additional service provider information for query. HS2.0 has multiple different type of service provider indicators but only SSID/HESSID and max three Organization Identifiers (OIs) can be included into the beacon. There are no fully qualified domain names (FQDNs) in the beacon, for example.

### SUMMARY

According to certain embodiments, a method can include determining whether more network access related information is available than can fit in a beacon. The method can also include sending the beacon with some network access related information. The method can further include including, with the beacon, an indicator regarding whether additional network access related information is available, based on the determination of whether more network access related information is available than can fit in the beacon.

In certain embodiments, a method can include receiving a beacon including at least some network access related information. The method can also include processing an indicator with the beacon. The indicator is configured to indicate whether more network access related information is available than can fit in the beacon. The method can further include querying an access node for more network access related information based on processing the indicator.

An apparatus, according to certain embodiments, can include at least one processor and at least one memory including computer program code. The at least one memory and the computer program code can be configured to, with the at least one processor, cause the apparatus at least to determine whether more network access related information is available than can fit in a beacon. The at least one memory and the computer program code can also be configured to, with the at least one processor, cause the apparatus at least to send the beacon with some network access related information. The at least one memory and the computer program code can further be configured to, with the at least one processor, cause the apparatus at least to include, with the beacon, an indicator regarding whether additional network access related information is available, based on the determination of whether more network access related information is available than can fit in the beacon.

An apparatus, in certain embodiments, can include at least one processor and at least one memory including computer program code. The at least one memory and the computer program code can be configured to, with the at least one processor, cause the apparatus at least to receive a beacon including at least some network access related information. The at least one memory and the computer program code can be configured to, with the at least one processor, cause the apparatus at least to process an indicator with the beacon. The indicator is configured to indicate whether more network access related information is available than can fit in the beacon. The at least one memory and the computer program code can further be configured to, with the at least one processor, cause the apparatus at least to query an access node for more network access related information based on processing the indicator.

According to certain embodiments, an apparatus can include means for determining whether more network access related information is available than can fit in a beacon. The apparatus can also include means for sending the beacon with some network access related information. The apparatus can further include means for including, with the beacon, an indicator regarding whether additional network access related information is available, based on the determination of whether more network access related information is available than can fit in the beacon.

In certain embodiments, an apparatus can include means for receiving a beacon including at least some network access related information. The apparatus can also include means for processing an indicator with the beacon. The indicator can be configured to indicate whether more network access related information is available than can fit in the beacon. The apparatus can further include means for querying an access node for more network access related information based on processing the indicator.

A computer program product can, according to certain embodiments, encode instructions for performing a process. The process can be any of the above-described methods.

non-transitory computer readable medium can, in certain embodiments, be encoded with instructions that, when executed in hardware, cause an apparatus at least to perform a process. The process can be any of the above-described methods.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates a system according to certain embodiments.

### DETAILED DESCRIPTION

Since MLF may inherently be an LTE radio, MLF may be limited with the same constraints as LTE radio. This may be relevant, for example, to system information block one (SIB1) size. SIBs may be MLF equivalent to WLAN beacons. MLF beacon can be provided in a form of System Information. System Information may include different system information blocks, each conveying system information for different purposes and each scheduled in different frequency according their importance. SIB1 conveys network discovery information and is the most important SIB. A MLF AP may, therefore, be unable to include to the SIB information blocks all service providers that it might serve. SIB size may be highly sensitive in all third generation partnership project (3GPP) radio systems. Thus, a query protocol may be included into the MLF radio as a deviation from the LTE radio to allow a UE discover all service providers. Such a protocol already exists in HS2.0, as mentioned above.

FQDN may be a primary mechanism to recognize service providers in non-MNO MLF mode. When a UE searches for a network, the UE may be able to decode information from the SIBs. If MLF supports non-MNO mode then service providers may be indicated in new SIB elements. Due to SIB size limitations, only a few non-MNO service providers may be included into the SIB, especially if these are indicated using FQDNs. Even if some shorter form than FQDN is used to identify service providers, there is limited space for them in the system information, especially in SIB1. The MLF network however may provide services for a much larger customer base. Such users that do not detect a suitable service provider from the SIB information may need to contact each MLF AP explicitly and query additional service provider information.

This querying may not necessarily be limited only to idle mode. Even when connected to a such an AP, the UE may still need to continue looking for better cells for potential handover or movement as MLF network may have only local coverage and the UE may be able to operate in multiple MLF networks. Also, a MLF UE may or may not have the availability of an LTE type of handover, as such handover may not be defined.

This querying is a deviation from LTE mode and can potentially cause considerable signaling, as there may be numerous such APs in the field, especially if MLF is used in residential cases.

By contrast, according to certain embodiments, a UE can avoid making such query when a particular indicator in a beacon is set, even though the UE does not find suitable service providers from the beacon.

More particularly, according to certain embodiments, an indication can be included with the broadcast information, for example in SIB, as to whether all network access related information is actually included in to the respective broadcast information. Such an indication can avoid the need to explicitly poll and query each MLF AP for additional network selection information if a UE does not find a suitable network based on the beacon information. Network access related information here could be limited also to service provider information alone as network access related information could include also other information not relevant for network detection.

More particularly, a new bit, which can be called ‘Additional Service Provider Information Available,’ can be included into SIB1 or some other SIB. Residential MLF networks may not contain such information. Thus, UEs looking at different APs to provide service can avoid querying APs that do not have this bit set. Thus, the UEs can avoid transmitting any data for these networks. This omission may save both spectrum and UE battery lifetime. It may also allow UEs to implement a more effective network searching method, which may improve overall service experience.

Certain embodiments are also applicable to HS2.0. In HS2.0, the service provider may provide home service provider identifiers for the HS2.0 subscriber for network discovery. If these include, for example, FQDNs or PLMNs then the UE may have to query all HS2.0 APs to detect supported FQDNs/PLMNs. An indicator in the beacon can tell if an AP has any service provider information for query or how many they are. Currently, WLAN beacon information does not indicate which query data types are available. HS2.0 AP might only indicate service providers via OIs or using SSID/HESSID values in the beacon. The HS2.0 query protocol name is ANQP.

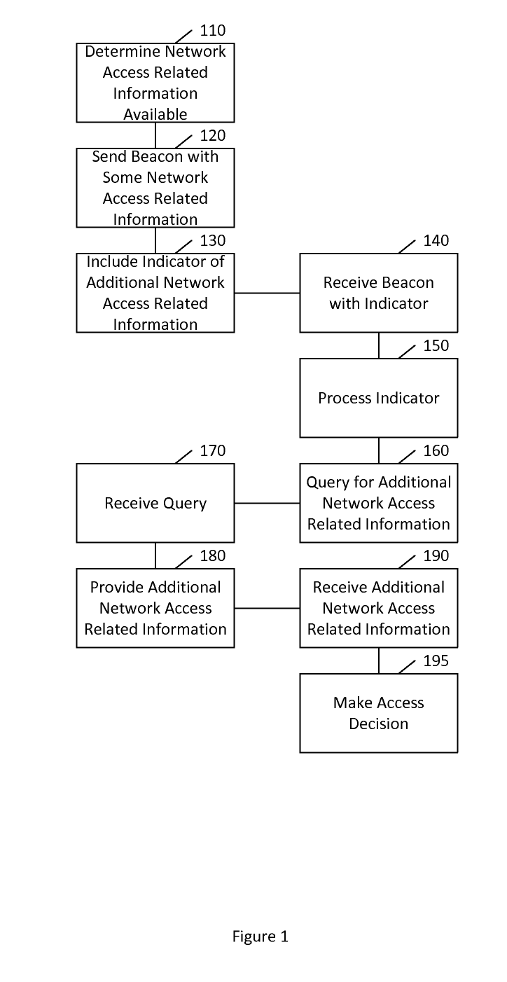

FIG. 1 illustrates a method according to certain embodiments. As shown in FIG. 1, a method can include, at 110, determining whether more network access related information is available than can fit in a beacon. The network access related information can be or include service provider information. The determining may be performed an access node, such as an access point, evolved Node B, MLF access point, WLAN access point, or similar device. The determination may be the result of a predetermined configuration. For example, the determination may be negative in the case of residential use. A residential use WLAN access point may be configured such that all the network access related information is always able to fit in the beacon. On the other hand, some MLF access points may be configured such that they always have more network access related information available than can fit in the beacon. Thus, in such cases the determination may always be positive in the case of such access points. The determining step, therefore, may be controlled by a predetermined configuration of the access node.

The method can also include, at 120, sending the beacon with some network access related information. The method can further include, at 130, including, with the beacon, an indicator regarding whether additional network access related information is available, based on the determination of whether more network access related information is available than can fit in the beacon. The sending and including can also be performed by an access node.

The method can also include, at 140, receiving the beacon including at least some network access related information. The method can further include, at 150, processing an indicator with the beacon. The indicator can be configured to indicate whether more network access related information is available than can fit in the beacon. The indicator can be configured to indicate how many additional network access related information elements are available than can fit in the beacon, or size of this information for reception. The method can additionally include, at 160, querying an access node for more network access related information based on processing the indicator. The receiving, processing, and querying can be performed by a user equipment.

The beacon can provided in a system information block, such as system information block one or another system information block. More generally, the beacon can be provided in a broadcast communication.

In response to receiving the query at 170, an access point or other network node can respond to a querying user equipment by providing, at 180, additional network access related information, which may include service provider information, like a FQDN and a PLMN. At 190, the user equipment can receive the response. At 195, the user equipment can make an access decision based on the received information.

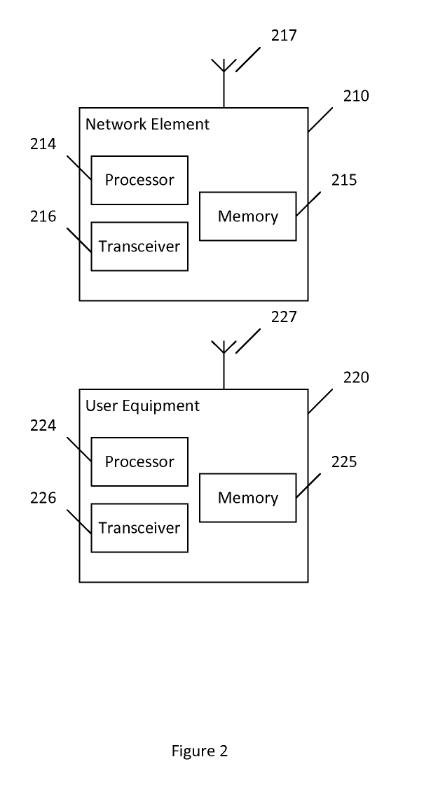

FIG. 2 illustrates a system according to certain embodiments of the invention. It should be understood that each block of the flowchart of FIG. 1 may be implemented by various means or their combinations, such as hardware, software, firmware, one or more processors and/or circuitry. In one embodiment, a system may include several devices, such as, for example, network element 210 and user equipment (UE) or user device 220. The system may include more than one UE 220 and more than one network element 210, although only one of each is shown for the purposes of illustration. A network element can be an access point, a base station, an eNode B (eNB), or any other network element.

Each of these devices may include at least one processor or control unit or module, respectively indicated as 214 and 224. At least one memory may be provided in each device, and indicated as 215 and 225, respectively. The memory may include computer program instructions or computer code contained therein, for example for carrying out the embodiments described above. One or more transceiver 216 and 226 may be provided, and each device may also include an antenna, respectively illustrated as 217 and 227. Although only one antenna each is shown, many antennas and multiple antenna elements may be provided to each of the devices. Other configurations of these devices, for example, may be provided. For example, network element 210 and UE 220 may be additionally configured for wired communication, in addition to wireless communication, and in such a case antennas 217 and 227 may illustrate any form of communication hardware, without being limited to merely an antenna.

Transceivers 216 and 226 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example.

A user device or user equipment 220 may be a mobile station (MS) such as a mobile phone or smart phone or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof The user device or user equipment 220 may be a sensor or smart meter, or other device that may usually be configured for a single location.

In an exemplifying embodiment, an apparatus, such as a node or user device, may include means for carrying out embodiments described above in relation to FIG. 1.

Processors 214 and 224 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof The processors may be implemented as a single controller, or a plurality of controllers or processors. Additionally, the processors may be implemented as a pool of processors in a local configuration, in a cloud configuration, or in a combination thereof.

For firmware or software, the implementation may include modules or unit of at least one chip set (e.g., procedures, functions, and so on). Memories 215 and 225 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a related service provider. The memory may be fixed or removable.

The memory and the computer program instructions may be configured, with the processor for the particular device, to cause a hardware apparatus such as network element 210 and/or UE 220, to perform any of the processes described above (see, for example, FIG. 1). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 2 illustrates a system including a network element 210 and a UE 220, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### LIST OF ABBREVIATIONS

ANQPAccess Network Query protocol
AP Access Point
FQDNFully Qualified Domain Name
HS2.0 Hotspot 2.0 defined by Wi-Fi Alliance
LBT Listen-Before-Talk
MLF LTE technology based standalone network operating fully in unlicensed band—also sometimes abbreviated as MF
MNO Mobile Network Operator
MuLTEFire a proprietary name for MLF
NAS Non-Access Stratum
SIB System Information Block
SSID Service Set Identifier
HESSID Homogenous Enhanced SSID
UE User Equipment
WLAN Wireless Local Area Network

1. A method, comprising:
determining whether more network access related information is available than can fit in a beacon;
sending the beacon with some network access related information; and
including, with the beacon, an indicator regarding whether additional network access related information is available, based on the determination of whether more network access related information is available than can fit in the beacon.

2. A method, comprising:
receiving a beacon including at least some network access related information;
processing an indicator with the beacon, wherein the indicator is configured to indicate whether more network access related information is available than can fit in the beacon; and
querying an access node for more network access related information based on processing the indicator.

3. The method of claim 1, wherein the beacon is provided in a system information block.

4. The method of claim 3, wherein the system information block comprises system information block one.

5. The method of claim 1, wherein the beacon is provided in a broadcast communication.

6. The method of claim 1, wherein the network access related information comprises service provider information.

7. An apparatus, comprising:
at least one processor; and
at least one memory including computer program code,
wherein the at least one memory and the computer program code are configured to, with the at least one processor, cause the apparatus at least to determine whether more network access related information is available than can fit in a beacon;
send the beacon with some network access related information; and
include, with the beacon, an indicator regarding whether additional network access related information is available, based on the determination of whether more network access related information is available than can fit in the beacon.

8. An apparatus, comprising:
at least one processor; and
at least one memory including computer program code,
wherein the at least one memory and the computer program code are configured to, with the at least one processor, cause the apparatus at least to
receive a beacon including at least some network access related information;
process an indicator with the beacon, wherein the indicator is configured to indicate whether more network access related information is available than can fit in the beacon; and
query an access node for more network access related information based on processing the indicator.

9. The apparatus of claim 7, wherein the beacon is provided in a system information block.

10. The apparatus of claim 9, wherein the system information block comprises system information block one.

11. The apparatus of any of claim 7, wherein the beacon is provided in a broadcast communication.

12. The apparatus of claim 7, wherein the network access related information comprises service provider information.

13-19. (canceled)

20. A non-transitory computer readable medium encoded with instructions that, when executed in hardware, cause an apparatus at least to perform a process, the process comprising the method according to claim 1.

21. A non-transitory computer readable medium encoded with instructions that, when executed in hardware, cause an apparatus at least to perform a process, the process comprising the method according to claim 2.

22. The method of claim 2, wherein the beacon is provided in a system information block.

23. The method of claim 22, wherein the system information block comprises system information block one.

24. The method of claim 2, wherein the beacon is provided in a broadcast communication.

25. The method of claim 2, wherein the network access related information comprises service provider information.
